(19) United States
(12) Patent Application Publication
(10) Pub. No.: US 2006/0113704 A1
(43) Pub. Date: Jun. 1, 2006

(54) Method for molding products

(75) Inventors: Yoshimasa Omiya, Aichi-ken (JP); Hiromi Hyuga, Aichi-ken (JP); Daiichiro Kawashima, Aichi-ken (JP); Haruo Okada, Nagano-ken (JP); Akihiro Kitamura, Hirakata-shi (JP)

Correspondence Address: POSZ LAW GROUP, PLC, 12040 SOUTH LAKES DRIVE, SUITE 101, RESTON, VA, 20191, US

(73) Assignees: TOYODA GOSEI CO., LTD., Aichi-Ken (JP); NISSEI PLASTIC INDUSTRIAL CO., LTD., Nagano-ken (JP)

(21) Appl. No.: 11/284,129

(22) Filed: Nov. 22, 2005

(30) Foreign Application Priority Data
Nov. 30, 2004 (JP) 2004-347468

(51) Int. Cl. B29C 45/00

(52) U.S. Cl. 264/255; 264/328.2; 264/328.8

(57) ABSTRACT

According to a method for molding wheel caps, a base member of a thermoplastic resin is molded using a first cavity mold. Then, a film is formed on the base member by injecting a thermosetting coating material into a film forming cavity defined between a surface of the base member and a second cavity mold, such that the film forming cavity is filled with the coating material. The temperature of the second cavity mold is set to a temperature lower than the curing temperature of the thermosetting coating material at the time of injection of the thermosetting coating material into the film forming cavity.

### BACKGROUND OF THE INVENTION

The present invention relates to a method for molding products having layers.

A molded product such as a vehicle wheel cap is formed by molding a base member and then forming a film on the base member. For example, Japanese Laid-Open Patent Publication No. 2003-334838 discloses such a method for forming a film on a base member. In this method, a thermosetting coating material is injected into a cavity defined between a cavity mold and the surface of a base member made of thermoplastic resin, so that a film is formed on the base member.

According to the above mentioned publication, prior to injecting the thermosetting coating material into the cavity, the temperature of the cavity mold is set to the curing temperature of the coating material. The coating material is injected while the curing temperature is maintained. Therefore, the thermosetting coating material is spread over the entire cavity while being gradually cured. That is, the coating material fills the cavity with a lowered fluidity. As a result, the filling time of the coating material into the cavity is extended. Also, since the material starts curing and the viscosity of the material is increased, the material hardly mixes at merging points of flows. Therefore, flow merging points of the material in the film are likely to form weld marks.

Further, for example, when applying a metallic finish to a molded product, metallic flake pigment is mixed in the thermosetting coating material. If the method according to the above described publication is used, the lowered fluidity of the coating material disturbs flows of the coating material, which disturbs the alignment of the flakes of the metallic pigment. If the alignment of the flakes of the metallic pigment is disturbed, darkening due to diffused reflection is likely to occur on the exposed surface of the film, particularly in sections of disturbed alignment.

### SUMMARY OF THE INVENTION

Accordingly, it is an objective of the present invention to provide a method for molding products that improves the appearance quality of the products.

To achieve the foregoing and other objectives of the present invention, a method for molding products is provided. The method includes: molding a first layer of a thermoplastic resin using a first cavity mold; forming a second layer on the first layer by injecting a thermosetting coating material into a second layer forming cavity defined between a surface of the first layer and a second cavity mold, such that the second layer forming cavity is filled with the coating material; and setting the temperature of the second cavity mold to a temperature lower than the curing temperature of the thermosetting coating material at the time of injection of the thermosetting coating material into the second layer forming cavity.

The present invention also provides a method for molding wheel caps. The method includes: molding a base member of a thermoplastic resin using a first cavity mold; forming a film on the base member by injecting a thermosetting coating material into a film forming cavity defined between a surface of the base member and a second cavity mold, such that the film forming cavity is filled with the coating material; and setting the temperature of the second cavity mold to a temperature lower than the curing temperature of the thermosetting coating material at the time of injection of the thermosetting coating material into the film forming cavity.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view illustrating a vehicle to which wheel caps according to a preferred embodiment are attached;

FIG. 2A is a perspective view illustrating the wheel cap shown in FIG. 1;

FIG. 2B is a cross-sectional view taken along line 2B-2B in FIG. 2A;

FIG. 2C is an enlarged view showing encircled part 2C of FIG. 2B;

FIG. 3 is a cross-sectional view illustrating a clamped state of a first mold in a first step;

FIG. 4 is a cross-sectional view illustrating the molded state of a base member in the first step;

FIG. 5 is a cross-sectional view illustrating a clamped state of a second mold in a second step;

FIG. 6 is a cross-sectional view illustrating the molded state of a film in the second step; and

FIG. 7 is a graph showing the relationship of the temperature of the second cavity mold, the brightness of the wheel cap, and the state of weld marks.

### DETAILED DESCRIPTION OF THE PREFERRED EMBODIMENTS

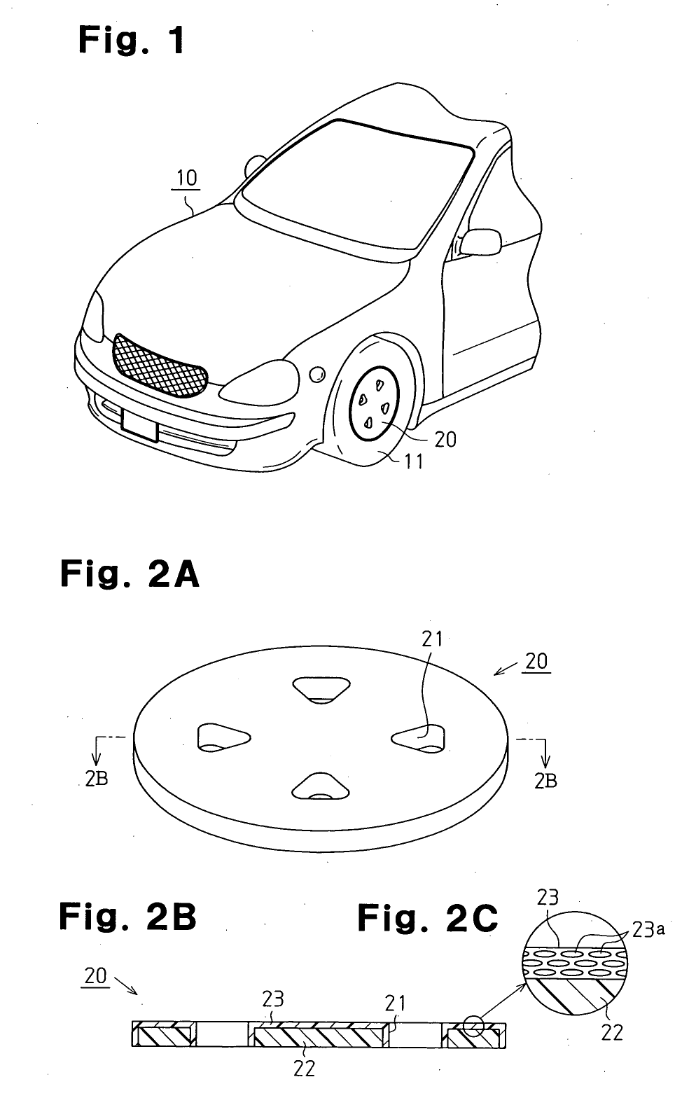

A method for molding vehicle wheel caps according to a preferred embodiment of the present invention will now be described with reference to FIGS. 1 to 7.

As shown in FIG. 1, a wheel cap 20, which is a molded product, covers a wheel (not shown) to which a tire 11 of a vehicle 10 is attached.

As shown in FIG. 2A, the wheel cap 20 is shaped like a disc. The wheel cap 20 has four openings 21 (through holes), which are arranged at equal angular intervals about the center of the wheel cap 20. As shown in FIG. 2B, the wheel cap 20 includes a first layer, which is a base member 22, and a second layer, which is a film 23 formed on the base member 22. The base member 22 is made of a thermoplastic resin, and the film 23 is made of a thermosetting coating material. The film 23 forms the exposed surface of the wheel cap 20. To make the exposed surface of the wheel cap 20 appear metallic, the film includes a great amount of metallic flake pigment 23a. The alignment of the flakes of the metallic pigment 23a is set in a certain state in the film 23.

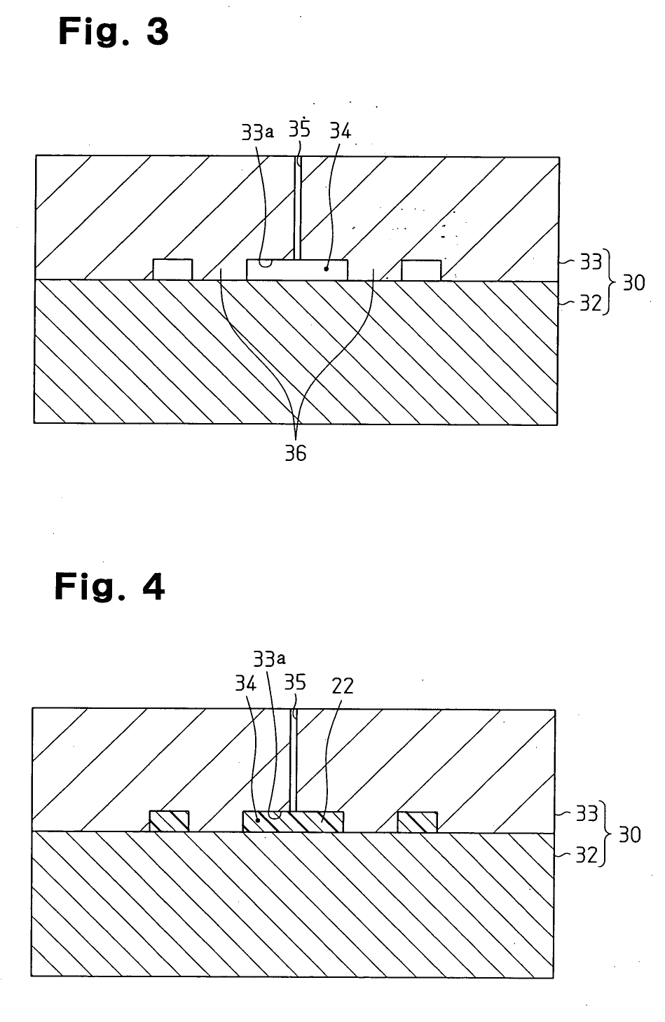

A method for manufacturing the wheel caps 20 will now be described with reference to FIGS. 3 to 7.

The wheel cap 20 is manufactured using a first mold set 30 and a second mold set 31.

As shown in FIG. 3, the first mold set 30 includes a core mold 32 and a first cavity mold 33. The first mold set 30 is clamped in the vertical direction so that a cavity 34 for forming the base member 22 is defined between the core mold 32 and the first cavity mold 33. A first gate 35 is formed in the first cavity mold 33 such that the first gate 35 communicates with a center portion of the base forming cavity 34. Through the first gate 35, thermoplastic resin, which is the material for the base member 22, is injected into the base forming cavity 34. Projections 36 are formed on a cavity surface 33a of the first cavity mold 33. The projections 36 are used for forming the openings 21 in the base member 22.

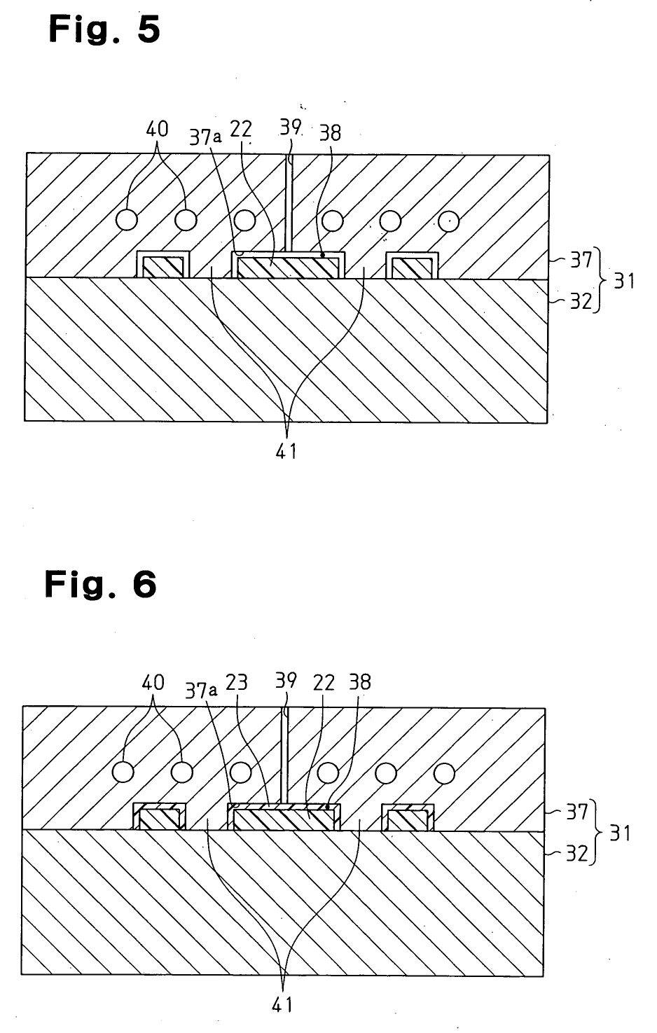

As shown in FIG. 5, the second mold set 31 includes the core mold 32 and a second cavity mold 37. That is, the second mold set 31 is formed by replacing the first cavity mold 33 in the core mold 32 by the second cavity mold 37. By clamping the core mold 32 and the second cavity mold 37 of the second mold set 31 in the vertical direction, a cavity 38 for forming the second layer, or film 23, is defined between the surface of the base member 22 and the second cavity mold 37. A second gate 39 is formed in the second cavity mold 37 such that the second gate 39 communicates with a center portion of the film forming cavity 38. Through the second gate 39, thermosetting coating material, which is thermosetting liquid paint, for forming the film 23, is injected into the film forming cavity 38. Passages 40 are formed in the second cavity mold 37 in the vicinity of a cavity surface 37a. Thermal medium (water in this embodiment) passes through the passages 40. In particular, a water heater (not shown) supplies water of a predetermined temperature to the passages 40 to adjust the temperature of the second cavity mold 37 (specifically, the temperature of the cavity surface 37a). Projections 41 are formed on the cavity surface 37a of the second cavity mold 37. The projections 41 are used for forming the openings 21 in the film 23.

The process for manufacturing the wheel cap 20 includes a first step for forming the base member 22 using the first mold set 30, and a second step for forming the film 23 on the surface of the base member 22.

In the first step, the core mold 32 and the first cavity mold 33 are clamped as shown in FIG. 3 so that the base forming cavity 34 is defined. As shown in FIG. 4, molten thermoplastic resin is injected into the base forming cavity 34 so that the resin fills the cavity 34. The resin is then cooled and cured so that the base member 22 with the openings 21 is molded. Subsequently, the first cavity mold 33 is moved upward to open the first mold set 30. After replacing the first cavity mold 33 with the second cavity mold 37, the second step is performed.

In the second step, with the base member 22, which has been molded in the first step, placed on the core mold 32, the core mold 32 and the second cavity mold 37 are clamped so that the film forming cavity 38 is defined between the surface of the base member 22 and the second cavity 37. At this time, the projections 41 are inserted into the openings 21 formed in the base member 22 in the first step. Subsequently, water of the predetermined temperature is caused to pass through the passages 40 in the second cavity mold 37 to set the temperature of the second cavity mold 37 (particularly, the cavity surface 37a) at a temperature lower than the curing temperature of the thermosetting liquid paint (preferably in the range between 60 and 100 degrees centigrade inclusive, and 70 degrees centigrade in this embodiment). At this time, the difference between the temperature of the second cavity mold 37 and the curing temperature of the thermosetting liquid paint is 40 degrees centigrade in this embodiment. The temperature difference may vary in the range between 10 to 50 degrees centigrade inclusive, and preferably in the range between 20 and 40 degrees centigrade inclusive. In this state, the thermosetting liquid paint is injected from the gate 39 into a center of the film forming cavity 38. The thermosetting liquid paint contains a great amount of metallic flake pigment 23a, which is made, for example, of mica, aluminum, copper, or a copper alloy.

Since the temperature of the second cavity mold 37 (particularly, the cavity surface 37a) is lower than the curing temperature of the thermosetting liquid paint, curing of the paint does not advance. Without losing fluidity, the paint is quickly injected into the film forming cavity 38 in radial directions to fill the cavity 38 in a short time. At this time, the alignment of the flakes of the metallic pigment 23a in the paint is set in a certain state by the momentum of the flow of the paint. Subsequently, as shown in FIG. 6, immediately after the paint fills the film forming cavity 38, water of the predetermined temperature is supplied to the passages 40 of the second cavity 37 so that the temperature of the second cavity 37 (particularly, the temperature of the cavity surface 37a) is increased to a temperature equal to or higher than the curing temperature of the paint (120 degrees centigrade in this embodiment).

At this time, if the temperature of the second cavity mold 37 is increased to a temperature equal to or higher than the curing temperature of the paint too early, the fluidity of the paint is prematurely lowered, and the alignment of the flakes of the metallic pigment 23a is disturbed. On the other hand, if the temperature of the second cavity mold 37 is increased to a temperature equal to or higher than the curing temperature of the paint too late relative to the completion of filling of the cavity 38 with the paint, the alignment of the flakes of the metallic pigment 23a, which has been set in the certain state, is disturbed again in the highly fluid paint due to the heat of the second cavity mold 37. The brightness is lowered due to the disturbed alignment of the flakes of the metallic pigment 23a. Therefore, it is preferable that, after filling the film forming cavity 38 with the paint, the temperature of the second cavity mold 37 be increased to a temperature equal to or higher than the curing temperature of the second cavity 37 as quickly as possible.

When the temperature of the second cavity mold 37 is set to 120 degrees centigrade, the thermosetting liquid paint is heated and cured so that the film 23 is formed on the surface of the film. In this manner, the wheel cap 20 is molded through the first step and the subsequent second step. After the wheel cap 20 is molded, the second cavity mold 37 is moved upward, and the wheel cap 20 is removed from the second mold set 31.

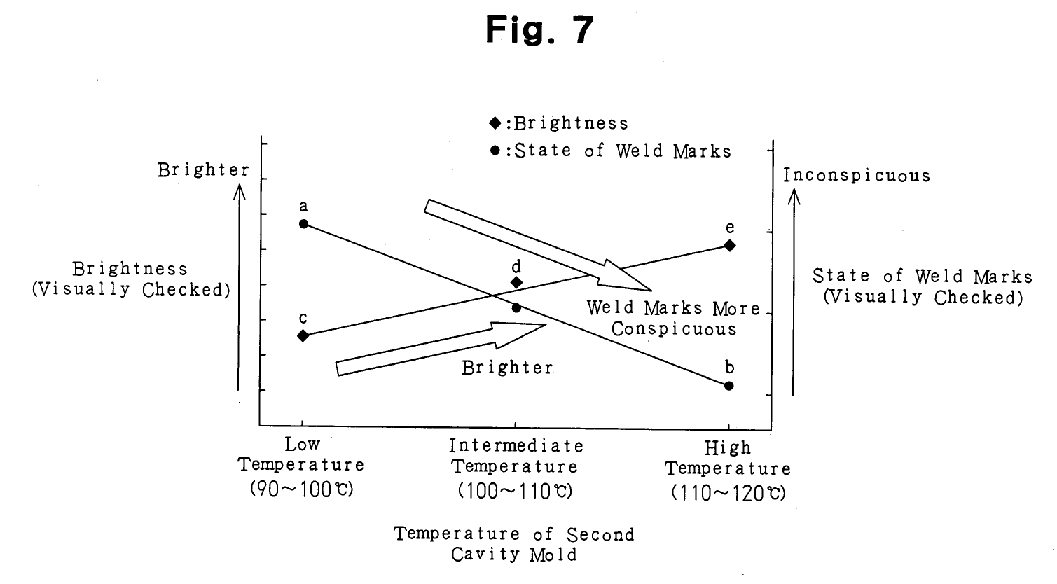

Next, the relationship of the temperature of the second cavity mold 37, the brightness of the wheel cap, and the state of weld marks will be described with reference to FIG. 7.

FIG. 7 is a graph showing the relationship among the temperature of the second cavity mold 37, the brightness of the wheel cap 20, and the state of weld marks. Specifically, the graph shows the relationship in cases where the temperature of the second cavity mold 37 from the time of the start of injection of the paint into the film forming cavity 38 to the time of completion of the filling is maintained in various temperature ranges, namely a low temperature (90 to 100 degrees centigrade), an intermediate temperature (100 to 110 degrees centigrade), and a high temperature (110 to 120 degrees centigrade).

If the second cavity mold 37 is maintained at the low temperature, although weld marks in the formed film 23 do not stand out visibly as indicated by point a, the brightness is not visibly sufficient as indicated by point c in FIG. 7. If the second cavity mold 37 is maintained at the high temperature, although a sufficient brightness of the formed film 23 is obtained as indicated by point e, weld marks in the formed film 23 stand out as indicated by point b in FIG. 7. Further, if the second cavity mold 37 is maintained at the intermediate temperature, the brightness and the state of weld marks are intermediate, as indicated by points d in FIG. 7, between those of the case of the low temperature and those of the case of the high temperature.

As has been described, in the period from the time of start of injection of the thermosetting liquid paint into the film forming cavity 38 to the time of completion of the filling, the lower the temperature of the second cavity mold 37, the better the state of weld marks in the formed film 23 becomes. Also, the higher the temperature of the second cavity mold 37, the more improved the brightness of the formed film 23 becomes.

The above described embodiment has the following advantages.

(1) When injecting the thermosetting liquid paint into the film forming cavity 38, the thermosetting liquid paint is not cured. Thus, the thermosetting liquid paint is caused to fill the film forming cavity 38 without lowering the fluidity. Therefore, the thermosetting liquid paint is permitted to fill the film forming cavity 38 quickly, and formation of weld marks on the film 23 is suppressed. Therefore, the appearance quality of the surface of the film 23, that is, the appearance quality of the wheel cap 20 is improved.

(2) Since the metallic flake pigment 23a is mixed in the thermosetting liquid paint, the wheel cap 20 is finished in metallic color. As in advantage (1), since the thermosetting liquid paint is permitted to fill the film forming cavity 38 without lowering the fluidity, the momentum of the thermosetting liquid paint sets the alignment of the flakes in the metallic pigment 23a in a certain state in the film 23. Therefore, the reflected light from light irradiated onto the surface of the film 23 (the exposed surface of the wheel cap 20) is regularly reflected by the flakes of the metallic pigment 23a, which are set in a certain alignment, and advances in a certain direction, so that the reflected light is prevented from scattering. Thus, darkening due to diffusion of reflected light is prevented.

(3) After the film forming cavity 38 is filled with the thermosetting liquid paint, the temperature of the second cavity mold 37 is quickly changed to a temperature equal to or higher than the curing temperature of the thermosetting liquid paint, the metallic pigment 23a in the thermosetting liquid paint is prevented from settling toward the base member 22. Therefore, the flakes of the metallic pigment 23a dispersed in the film 23 are prevented from being gathered at the side corresponding to the base member 22. On the surface of the film 23 (the exposed surface of the wheel cap 20), substantially even and favorable brightness is obtained all over the entire surface, which improves the appearance of the wheel cap 20.

(4) From the start of injection of the thermosetting liquid paint into the film forming cavity 38 to the completion of filling, the temperature of the second cavity mold 37 is increased by 50 degrees centigrade (from 70 degrees centigrade to 120 degrees centigrade). That is, the range of the temperature control of the second cavity mold 37 is smaller than a range of the temperature control of the cavity mold in a typical injection molding using thermoplastic resin (the range of an 80 to 100 degrees centigrade temperature difference). Therefore, water (hot or cold) can be used as a thermal medium for controlling the temperature of the second cavity mold 37. As a result, instead of a cumbersome apparatus such as a boiler, a compact device such as a water heater can be used to control the temperature of the second cavity mold 37.

The above embodiment may be modified as follows.

At the time of start of the injection of the thermosetting liquid paint into the film forming cavity 38, the temperature difference between the temperature of the second cavity mold 37 and the curing temperature of the thermosetting liquid paint does not need to be in the range between 10 to 50 degrees centigrade inclusive. However, if the temperature difference is out of the range, the thermal medium for controlling the temperature of the second cavity mold 37 needs to be changed to steam or oil as necessary. In such cases, an apparatus such as a boiler needs to be used.

The metallic pigment 23a does not need to be mixed in the thermosetting liquid paint.

The second layer does not need to be the film 23 of the thermosetting liquid paint as long as the second layer is made of a thermosetting coating material.

The present invention may be applied to a method for molding not only the wheel cap 20, but also various types of moldings and bumpers.

When clamping the first mold set 30, either of the first cavity mold 33 or the core mold 32 may be moved.

When clamping the second mold set 31, either of the second cavity mold 37 or the core mold 32 may be moved.

The base member 22 may have two or more layers.

Therefore, the present examples and embodiments are to be considered as illustrative and not restrictive and the invention is not to be limited to the details given herein, but may be modified within the scope and equivalence of the appended claims.

1. A method for molding products, comprising:
molding a first layer of a thermoplastic resin using a first cavity mold;
forming a second layer on the first layer by injecting a thermosetting coating material into a second layer forming cavity defined between a surface of the first layer and a second cavity mold, such that the second layer forming cavity is filled with the coating material; and
setting the temperature of the second cavity mold to a temperature lower than the curing temperature of the thermosetting coating material at the time of injection of the thermosetting coating material into the second layer forming cavity.

2. The method according to claim 1, wherein metallic pigment is mixed into the thermosetting coating material.

3. The method according to claim 1, further comprising, after filling the second layer forming cavity with the thermosetting coating material, increasing the temperature of the second cavity mold to a temperature equal to or higher than the curing temperature of the thermosetting coating material.

4. The method according to claim 1, further comprising, at the time of injection of the thermosetting coating material into the second layer forming cavity, setting the temperature of the second cavity mold to a temperature that is lower than the curing temperature of the thermosetting coating material by 10 to 50 degrees centigrade.

5. The method according to claim 4, further comprising, at the time of injection of the thermosetting coating material into the second layer forming cavity, setting the temperature of the second cavity mold to a temperature that is lower than the curing temperature of the thermosetting coating material by 20 to 40 degrees centigrade.

6. A method for molding wheel caps, comprising:
molding a base member of a thermoplastic resin using a first cavity mold;
forming a film on the base member by injecting a thermosetting coating material into a film forming cavity defined between a surface of the base member and a second cavity mold, such that the film forming cavity is filled with the coating material; and
setting the temperature of the second cavity mold to a temperature lower than the curing temperature of the thermosetting coating material at the time of injection of the thermosetting coating material into the film forming cavity.
